(19) United States
(12) Patent Application Publication
(10) Pub. No.: US 2026/0160247 A1
(43) Pub. Date: Jun. 11, 2026

(54) WELDING SURFACE FOR BELLOWS AND DOWNHOLE MOTOR

(71) Applicant: Halliburton Energy Services, Inc., Houston, TX (US)

(72) Inventors: Steven Pyron, Tulsa, OK (US); Jason Eugene Hill, Bristow, OK (US); Bryan Coates, Leduc (CA)

(21) Appl. No.: 18/976,440

(22) Filed: Dec. 11, 2024

(51) Int. Cl. F04B 53/16; F04B 47/06; F16J 3/04

(52) U.S. Cl. CPC F04B 53/16; F04B 47/06; F16J 3/047

(57) ABSTRACT

A system can be used to facilitate a weld between a bellows unit and a downhole motor. The system can include the downhole motor, the bellows unit, and a flange. The bellows unit can be positioned downstream from the downhole motor. The flange can be positioned between the downhole motor and the bellows unit. The flange can include a welding surface adjacent to the bellows unit, and the welding surface can be sized and shaped to allow the bellows unit to be welded to the motor.

### TECHNICAL FIELD

The present disclosure relates generally to wellbore operations and, more particularly (although not necessarily exclusively), to a welding surface that can be used to weld a bellows unit to a motor that can be positioned in a wellbore.

### BACKGROUND

Wellbore operations may include various equipment, components, methods, or techniques to perform various tasks, such as fluid control, with respect to a wellbore. In some examples, the wellbore operations may involve using a downhole pump such as an electric submersible pump to control fluid flow with respect to the wellbore. The downhole pump can be positioned downhole in the wellbore to perform a subset of the wellbore operations. In some examples, auxiliary components may be useful to add to the downhole pump, but sufficiently attaching, such as to prevent leaks or other failures, the auxiliary components to the downhole pump can be difficult.

### BRIEF DESCRIPTION OF THE DRAWINGS

FIG. 1 is a diagram of a well system that can include a downhole pump welded with a bellows unit and positioned in a wellbore according to some aspects of the present disclosure.

FIG. 2 is a diagram of a bellows unit and a flange that can allow the bellows unit to be welded to a downhole pump according to some aspects of the present disclosure.

FIG. 3 is a zoomed view of a bellows unit and a flange that can allow the bellows unit to be welded to a downhole pump according to some aspects of the present disclosure.

FIG. 4 is a cut-away view of a bellows unit and a flange that can allow the bellows unit to be welded to a downhole pump according to some aspects of the present disclosure.

FIG. 5 is a flowchart of a process for welding a bellows unit to a downhole motor according to some aspects of the present disclosure.

### DETAILED DESCRIPTION

Certain aspects and examples of the present disclosure relate to a motor with below-positioned bellows unit for electrical submersible pumping (ESP) systems. The below-positioned bellows unit can be welded to the motor such as via a flange, via a bottom of the motor, or a combination thereof. An ESP system may include a type of artificial lift system that can be used to pump fluids, such as oil, water, etc., from a wellbore to the surface using an electrically powered pump, such as the motor, that can be positioned downhole in the wellbore. The bellows unit may be include a one-piece component that can be integrated into the motor via a machined flange, such as the flange, that can be welded to a motor connection point such as the bottom of the motor. In some examples, and additionally or alternatively with respect to the machined flange, the bellows unit can be welded to a bottom portion of the motor connection point. The bellows unit may include a series of metal convolutions, which may be wavy or corrugated structures designed to flex and compress as needed during operation of the ESP system. In some examples, welding the bellow unit to the flange or to the bottom of the motor may involve applying at least a semi-permanent connection, such as a mechanical weld, to the bellows unit and to the flange or the bottom of the motor to connect the bellows unit with the motor.

The bellows unit can include convolutions that may be engineered to accommodate oil volume changes and thermal expansion such as in high-temperature downhole conditions. By allowing for flexibility, the convolutions may help the bellows unit absorb variations in fluid volume and pressure without compromising structural integrity. The machined flange can include attachment features, such as a bolt pattern or sealing elements, that can be sized or shaped to create a secure and leak-resistant connection to the motor. The flange and the bellows unit may be constructed from materials that are weld-compatible, or that can otherwise be welded, which can facilitate strong and durable weld joints.

Other systems involving ESPs may rely on adapters, such as bolt-on or screw-in connections, to attach metal bellows to other components. The adapters may introduce potential leak paths in the other systems and may otherwise complicate assembly of the other systems. Leak paths may allow leaks to form in the other systems, and the leaks may degrade a performance, a useful lifespan, or a combination thereof of the other systems.

By integrating a one-piece, weldable design, into an ESP system, the ESP system may be less complicated, and perform better than, the other systems. The system can include a motor, a below-positioned bellows unit, a flange, other suitable components, or any combination thereof. The system may have a lesser number of components compared with the other systems, and the system may have fewer potential leak paths than the other systems. For example, since the system lacks the additional seals required by the other systems, the system may have a lower potential for developing leaks compared with the other systems. Additionally, welding the bellows unit to the motor connection point, such as via the flange or the bottom of the motor, may reduce assembly time and make a reclaim process of metal bellows units quicker and easier, which may reduce resource costs of the system and increase reliability of the system compared with the other systems.

In some examples, the motor with below-positioned bellows unit may include a custom-designed, in some examples single-piece, weldable, machined flange. The machined flange may be welded, such as directly or indirectly, to the metal convolutions of the bellows while also attaching, such as directly or indirectly, to the bottom of an ESP motor. In some examples, the ESP motor may include an induction motor, a permanent magnet motor, other suitable ESP motors, or any combination thereof. Direct connection pieces may have appropriate motor attachment features such as a bolt pattern and provisions for sealing elements. The machined flange may additionally or alternatively have a geometry and material to facilitate being welded to the metal bellows convolutions or to other direct connect features such as connection rings or flanges. For example, the machined flange may have a geometry that at least approximately matches a geometry of a surface of the metal bellows. Additionally or alternatively, the machined flange may have a first material that is weldable with a second material of the surface of the metal bellows. Well-centering devices, such as rub buttons or clamps, may be attached to the flange to aid in the positioning of the flange for being welded.

In some examples, the motor with below-positioned bellows unit may incorporate variations in materials used to suit different operational needs. The geometry of the motor, the below-positioned bellows unit, the machined flange, or any combination thereof, can also be adjusted, with changes in length, diameter, or bolt pattern to meet specific application requirements. The design may include ports for purposes such as filling, venting, or facilitating well fluid communication. Well-centering devices, like rub buttons, clamps, or external rings, can be either attached to or integrated within the motor, the below-positioned bellows unit, the machined flange, or any combination thereof. There may also be different ways to attach the metal bellows to the machined flange, including variations in welding techniques or using an attachment flange or ring. Features such as expansion joints, rings, flanges, or threaded pieces may be incorporated to enhance the connection.

In some examples, the bellows unit may be welded to the motor via a bottom portion of the motor. The machined flange may be omitted in this example, and the weld can be applied between a first surface of the bellows unit and a second surface of the bottom of the motor. The first surface may be approximately the same size as that of the second surface, approximately the same shape as that of the second surface, or a combination thereof. As used herein, approximately indicates that a recited value may vary, such as above or below, by 1%, 2%, 3%, 4%, 5%, from 5% to 10%, from 10% to 20%, and the like.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

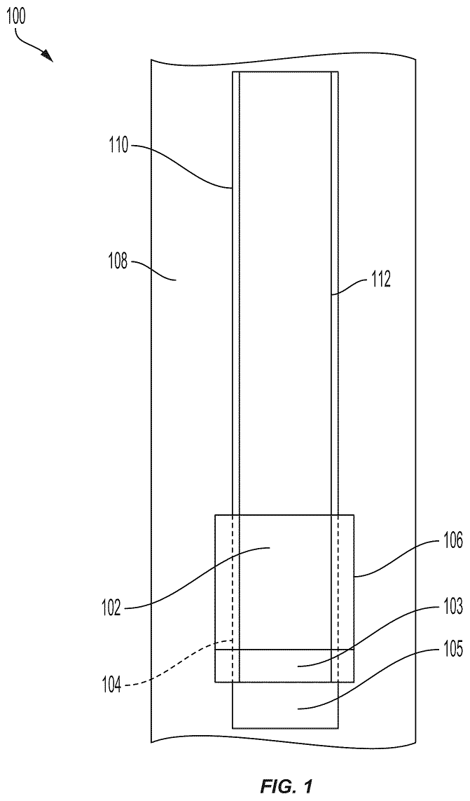

FIG. 1 is a diagram of a well system 100 that can include a downhole motor 102 welded with a bellows unit 105 and that can be positioned in a wellbore 108 according to some aspects of the present disclosure. In some examples, the downhole motor 102 can be, can include, or can be included in an ESP motor system. The downhole motor 102 can be encapsulated within a motor housing 106 that can be positioned within the wellbore 108. The downhole motor 102 may facilitate various wellbore operations such as fluid pumping or other suitable wellbore operations. The bellows unit 105 may be attached to the downhole motor 102 via a flange 103, though other examples may be possible. In the other examples, the flange 103 may be omitted or may be otherwise suitably positioned in the well system 100 to facilitate operation of the downhole motor 102. In some examples, the flange 103 may provide a robust welding surface that can allow the bellows unit 105 to be securely and at least semi-permanently connected to the downhole motor 102. By welding the bellows unit 105 to the downhole motor 102, a risk of fluids leaking in the well system 100 can be mitigated or eliminated.

The well system 100 may include a flow path 104 that can be defined through the bellows unit 105, through a central axis of the downhole motor 102, or a combination thereof. The flow path 104 may serve as a conduit for directing fluids, such as well fluids or produced material, such as produced hydrocarbons, from the downhole motor 102 through the bellows unit 105 and into connected tubing 110. The design of the flow path 104 may be engineered or otherwise adjusted to promote controlled and continuous fluid movement, which can help maintain consistent pressure and flow rates within the well system 100. The flow path 104 may be carefully aligned with the internal components of the bellows unit 105 to minimize disruptions and to facilitate smooth and uninterrupted fluid transfer.

The connected tubing 110 may be positioned around an exterior of the well system 100, or suitable components thereof, and can operate to contain and guide the fluid flow within the wellbore 108. For example, the connected tubing 110 may direct fluids to and from the downhole motor 102 while isolating the well system 100 from surrounding geological formations. Additionally or alternatively, the connected tubing 110 can provide structural support to ensure that the internal components of the well system 100 remain centered and properly aligned with respect to one another and within the wellbore 108.

A flow tube 112 may also be included within the well system 100. The flow tube 112 can be positioned within an interior region of the bellows unit 105, an interior region of the downhole motor 102, an interior region of the connected tubing 110, or any combination thereof, and the flow tube 112 may further direct fluid flow through the bellows unit 105 and into subsequent components of the well system 100. In some examples, the flow tube 112 may guide the fluids in an efficient manner, for example to minimize turbulence and to minimize pressure losses as the fluids move downstream.

In some examples, the wellbore 108 may provide an outer boundary for the well system 100 and can encompass the downhole motor 102, the bellows unit 105, the connected tubing 110, other suitable components, or any combination thereof. The wellbore 108 may also influence the operational environment, such as by subjecting the components to variations in pressure, temperature, and well fluid composition.

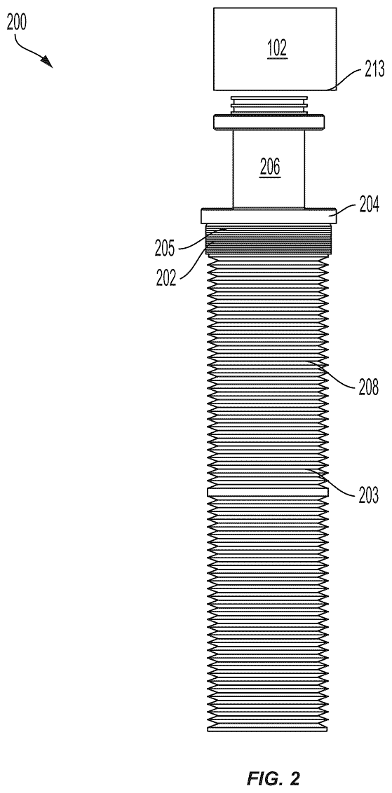

FIG. 2 is a diagram of a bellows unit 208 and a flange 206 that can be used to weld the bellows unit 208 to a downhole motor 102 according to some aspects of the present disclosure. The flange 206 may be designed, such as sized, shaped, or a combination thereof, to be bolted, such as directly or indirectly, to a bottom of the downhole motor 102. In some examples, the flange 206 may serve as a structural interface, may serve as a functional interface, or a combination thereof. The flange 206 may be used in place of adapter components that use seals or other components that may introduce potential leak paths into a system that includes the downhole motor 102. The flange 206 may provide a secure connection point for the bellows unit 208 with respect to the downhole motor 102. In some examples, the flange 206 may simplify the assembly process for the downhole motor 102 and may reduce potential leak paths in the downhole motor 102.

The bellows unit 208 may include a threaded section 202, which may provide a way to connect a protective housing over the bellows unit 208. That is, a protective housing may be positioned around the bellows unit 208 and may be coupled with the bellows unit 208 by being threaded into the threaded section 202. The threaded section 202 may be sized or shaped to accommodate the protective housing that can shield the bellows unit 208 from environmental damage and wear in the wellbore 108. The bellows unit 208, which may begin approximately at the threaded section 202 and may extend downstream therefrom, may be constructed with a series of convolutions 203 that can allow the bellows unit 208 to flex and absorb changes in oil volume and thermal expansion. The bellows unit 208 may increase structural integrity of a system that includes the downhole motor 102 and the bellows unit 208 in fluctuating wellbore environments. The convolutions 203 can be welded to a welding surface 204, which can be a specially prepared area on the flange 206. The welding surface 204 may include a precise contour to ensure a robust and leak-resistant weld. For example, the welding surface 204 may be sized, shaped, etc. to at least approximately match a mating surface on the bellows unit 208 and opposite the welding surface 204.

In some examples, the system 200 may include a first surface 205 on a top portion of the bellows unit 208, a welding surface 204 on the flange 206, or a combination thereof that are specifically designed for a secure and efficient weld. The first surface 205 on the bellows unit 208 may have a first normal line that can extend therefrom, and the welding surface 204 on the flange 206 may have a second normal line that can extend therefrom. When the first surface 205 is welded to the welding surface 204, the first normal line may extend in an opposite direction from the second normal line, creating a precise and aligned weld configuration. Additionally or alternatively, the first surface 205 on the bellows unit 208 may have a first shape and a first thickness, and the welding surface 204 on the flange 206 may have a second shape and a second thickness. The first shape may be approximately the same as the second shape, and the first thickness may be approximately the same as the second thickness. The similarity in shape and thickness between the first surface 205 and the welding surface 204 may facilitate a uniform and reliable weld, which can enhance the overall strength and integrity of the system 200 while reducing the likelihood of weak points or stress concentrations at the weld joint.

In some examples, the flange 206 may be omitted, and the bellows unit 208 can be welded to the downhole motor 102. In such examples, the bellows unit 208 may be welded directly to a bottom portion of the downhole motor 102. In such examples, the first surface 205 may be welded to a second surface 213 that may be positioned opposite the first surface 205 and on the bottom portion of the downhole motor 102. The first surface 205 on the bellows unit 208 may have a first shape and a first thickness, and the second surface 213 on the bottom of the downhole motor 102 may have a third shape and a third thickness. The first shape may be approximately the same as the third shape, and the first thickness may be approximately the same as the third thickness. The similarity in shape and thickness between the first surface 205 and the second surface 213 may facilitate a uniform and reliable weld, which can enhance the overall strength and integrity of the system 200 while reducing the likelihood of weak points or stress concentrations at the weld joint.

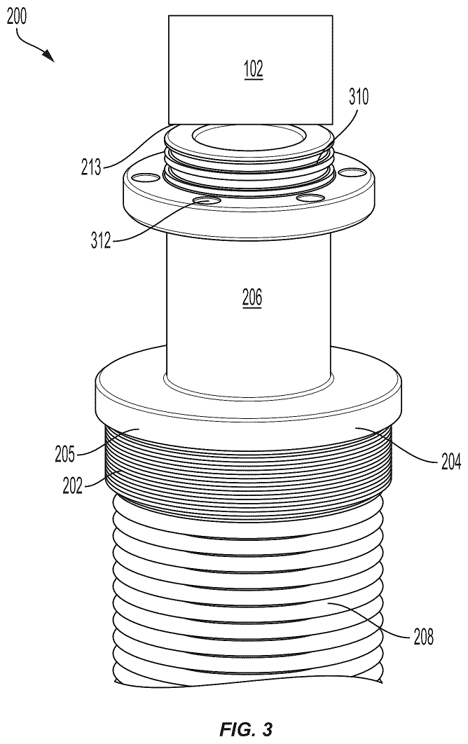

FIG. 3 is a zoomed view of a bellows unit 208, a flange 206, and associated features that can facilitate welding and attachment of the bellows unit 208 to a downhole motor 102. As illustrated in FIG. 3, the system 200 can include the flange 206, the bellows unit 208, and the downhole motor 102, though any additional, alternative, or fewer components are possible for the system 200. The flange 206 can be or include an interface between the bellows unit 208 and the downhole motor 102. The flange 206 may include one or more through holes, such as through hole 312, that can be arranged around a perimeter of the flange 206. The one or more through holes may be used for bolting the flange 206 to the downhole motor 102. In some examples, the one or more through holes in the flange 206 may be used to receive bolts that secure the flange directly to the motor 306.

In some examples, the flange 206 may include one or more recesses such as recess 310. As illustrated in FIG. 3, the flange 206 includes two recesses, though any other suitable number (e.g., less than two or more than two) of recesses are possible to include in the flange 206. The recess 310 may be sized, shaped, or otherwise arranged to receive a seal such as an O-ring. In some examples, the recess 310, and any other suitable recesses in the flange 206, may be precision-machined to receive seals into corresponding grooves or recesses on a motor, such as the downhole motor 102, for forming a fluid-tight seal when the flange 206 is mated with the downhole motor 102.

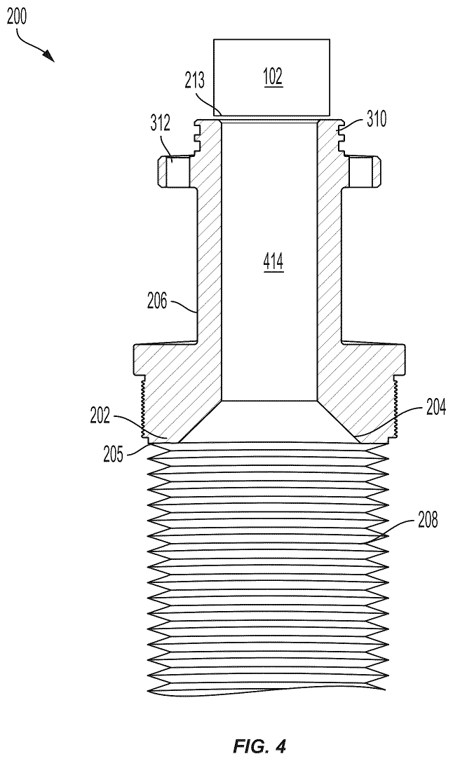

FIG. 4 is a cut-away view of a system 200 that includes a bellows unit 208, a flange 206, and associated features that allow the bellows unit 208 to be welded to a downhole motor 102. The flange 206 can be or include a connection point between the bellows unit 208 and the downhole motor 102. The flange 206 may include the welding surface 204, and the welding surface 204 on the flange 206 may facilitate a strong and reliable weld between the bellows unit 208 and the downhole motor 102, the flange 206, or a combination thereof. The welding surface 204 may be machined or contoured to ensure optimal material fusion to help form a durable connection that can withstand high-pressure and high-temperature conditions that may be experienced in wellbores such as the wellbore 108. The welded bond between the flange 206 and the bellows unit 208 can enhance an overall durability and reliability of the system 200.

The flange 206 can include the one or more recesses, such as the recess 310, to allow for O-rings or other suitable seals to be integrated into the flange 206 and to facilitate sealing a connection between the flange 206 and the downhole motor 102. In some examples, the one or more recesses may be sized or shaped to receive one or more O-rings, which, when compressed between the flange 206 and the downhole motor 102, may create a fluid-tight seal that prevents wellbore fluids from entering a housing of the downhole motor 102. The one or more recesses may be strategically positioned to optimize sealing effectiveness, and the use of high-performance O-ring materials may further ensure the longevity of the seal in harsh downhole conditions.

In some examples, the flange 206 may include or otherwise define a channel 414. The channel 414 may be positioned within the flange 206 to direct or manage the flow of well fluids, to reduce turbulence and pressure drops as the fluid moves through the system, or to perform other suitable operations. The channel 414 can also assist in equalizing pressure across the flange 206 and the bellows unit 208 for enhancing the stability and efficiency of the system 200. The design of the channel 414 may also facilitate the venting of trapped gases or may also allow for specific fluid communication paths, depending on the operational requirements. In some examples, the channel 414 may be sized, shaped, or arranged within the flange 206 to align with one or more corresponding channels of the downhole motor 102, one or more corresponding channels of the bellows unit 208, or a combination thereof. That is, the channel 414 may extend continuously across and past the ends of the flange 206 and into the downhole motor 102 and the bellows unit 208.

In some examples, the motor base, or a bottom portion of the downhole motor 102, may define a first inner channel with a first inner diameter, and the bellows unit 208 may define a second inner channel with a second inner diameter. When the bellows unit 208 is welded to the bottom portion of the downhole motor 102, such as via the flange 206, the first inner channel may be aligned with the second inner channel, and the first inner diameter may be approximately the same as the second inner diameter. The matching of alignment and diameter may facilitate smooth fluid flow through the system and may minimize pressure losses and enhance overall fluid transfer efficiency.

In some examples, the flange 206 may be omitted, and the bellows unit 208 may be welded to the bottom portion of the downhole motor 102. In such examples, the channel 414 may be formed from the union of the bellows unit 208 and the bottom portion of the downhole motor 102. That is, when the bellows unit 208 is welded to the bottom portion of the downhole motor 102, the channel 414 may be formed by the corresponding channels of the bellows unit 208 and the bottom portion of the downhole motor 102.

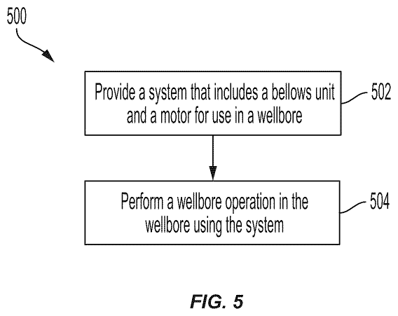

FIG. 5 is a flowchart of a process 500 for welding a bellows unit 208 to a downhole motor 102 and using the system for wellbore operations according to some aspects of the present disclosure. At block 502, a system, such as the system 200, is provided. The system 200 can include a bellows unit 208 and a downhole motor 102 for use in a wellbore such as the wellbore 108. The downhole motor 102 with bellows unit 208 may involve configuring the bellows unit 208 to be positioned downstream from the downhole motor 102. A flange 206, which can include the welding surface 204, may be used to securely weld the bellows unit 208 to the downhole motor 102. The welded connection can be designed to withstand the harsh conditions typically encountered in environments of the wellbore 108.

At block 504, a wellbore operation is performed in the wellbore 108 using the system 200. The wellbore operation may involve deploying the system 200 into the wellbore 108 and engaging in tasks like fluid pumping, pressure management, or other suitable downhole activities. The welded connection created between the bellows unit 208 and the downhole motor 102 may provide structural stability and may help minimize leak paths. The bellows unit 208 may flex to accommodate thermal expansion or volume changes in the oil.

In some examples, such as examples in which the flange 206 is integrated into the motor base, the process 500 may further include providing the downhole motor 102 with an integrated motor base in which the flange 206 is a part of the motor base itself. The flange 206 can be integrated into the motor base and may streamline the assembly process and reduce the number of separate components for constructing the system 200. In such examples, the bellows unit 208 can be welded directly to the motor base.

In some examples, the process 500 may involve using a flange 206, such as a separate flange, that may be manufactured separately from the downhole motor 102. The separate flange can be attached to the bottom portion of the downhole motor 102, and the bellows unit 208 may then be welded to the bottom portion of the downhole motor 102 via the separate flange.

In some examples, the bellows unit 208 can be provided in the system 200 and may include a series of metal convolutions, such as the convolutions 203, that extend from one end of the bellows unit 208 to an opposite end of the bellows unit 208. The convolutions 203 may allow the bellows unit 208, or the system 200, to flex and accommodate oil volume changes. Additionally or alternatively, the bellows unit 208 may include a set of threads at one end for facilitating a bellows housing to be connected with the bellows unit 208. The bellows unit 208 may have a welding surface, such as the first surface 205, that at least approximately matches the shape and thickness of the welding surface 204 of the flange 206 or of the separate flange.

In some examples, the process 500 may also involve aligning a channel 414 defined within the flange 206 to a corresponding channel within the bellows unit 208. The alignment can facilitate the efficient transfer of fluids through the system 200 and can minimize turbulence and pressure losses in the system 200. The channel 414 may be arranged to match the inner diameter of the bellows unit 208 for example for improving fluid flow and functionality of the system 200.

In some aspects, systems and methods for a weld facilitated between a bellows unit and a downhole motor using a flange or a bottom portion of the downhole motor are provided according to one or more of the following examples:
As used below, any reference to a series of examples is to be understood as a reference to each of those examples disjunctively (e.g., “Examples 1-4” is to be understood as “Examples 1, 2, 3, or 4”).

Example 1 is a system comprising: a motor positionable in a wellbore; a bellows unit positionable downstream from the motor; and a flange positionable between the motor and the bellows unit, the flange comprising a welding surface adjacent to the bellows unit, the welding surface sized and shaped to allow the bellows unit to be welded to the motor.

Example 2 is the system of example 1, wherein the flange is integrated into the motor and included in a motor base, and wherein the bellows unit is weldable to the motor via the motor base.

Example 3 is the system of example 1, wherein the flange is formable separate from the motor and is couplable with a lower surface of the motor to allow the bellows unit to be welded to the motor via the flange.

Example 4 is the system of example 1, wherein the bellows unit comprises: a plurality of convolutions extending from a first end of the bellows unit to a second end of the bellows unit; a set of threads positionable around the first end of the bellows unit to facilitate a connection between a bellows housing and the bellows unit; and a first surface positionable at the first end of the bellows unit, wherein the first surface is weldable to the welding surface to allow the bellows unit to be welded to the motor.

Example 5 is the system of example 4, wherein the first surface has a first normal line and the welding surface has a second normal line, and wherein the first normal line extends in an opposite direction from the second normal line when the first surface is welded to the welding surface.

Example 6 is the system of example 4, wherein the first surface has a first shape and a first thickness, wherein the welding surface has a second shape and a second thickness, wherein the first shape is approximately the same as the second shape, and wherein the first thickness is approximately the same as the second thickness.

Example 7 is the system of example 1, wherein the flange defines a first inner channel having a first inner diameter, wherein the bellows unit defines a second inner channel having a second inner diameter, wherein the first inner channel is aligned with the second inner channel when the bellows unit is welded to the motor, and wherein the first inner diameter is approximately the same as the second inner diameter.

Example 8 is a system comprising: a motor positionable in a wellbore, the motor comprising a motor base positionable on a downstream side of the motor, the motor base comprising a welding surface; and a bellows unit positionable downstream from the motor and positionable adjacent to the welding surface, the welding surface sized and shaped to allow the bellows unit to be welded to the motor.

Example 9 is the system of example 8, further comprising a flange integrated into the motor base, wherein the bellows unit is weldable to the motor via the flange of the motor base.

Example 10 is the system of example 9, wherein the flange is formable separate from the motor and is couplable with the motor base to allow the bellows unit to be welded to the motor via the flange.

Example 11 is the system of example 8, wherein the bellows unit comprises: a plurality of convolutions extending from a first end of the bellows unit to a second end of the bellows unit; a set of threads positionable around the first end of the bellows unit to facilitate a connection between a bellows housing and the bellows unit; and a first surface positionable at the first end of the bellows unit, wherein the first surface is weldable to the welding surface to allow the bellows unit to be welded to the motor.

Example 12 is the system of example 11, wherein the first surface has a first normal line and the welding surface has a second normal line, and wherein the first normal line extends in an opposite direction from the second normal line when the first surface is welded to the welding surface.

Example 13 is the system of example 11, wherein the first surface has a first shape and a first thickness, wherein the welding surface has a second shape and a second thickness, wherein the first shape is approximately the same as the second shape, and wherein the first thickness is approximately the same as the second thickness.

Example 14 is the system of example 8, wherein the motor base defines a first inner channel having a first inner diameter, wherein the bellows unit defines a second inner channel having a second inner diameter, wherein the first inner channel is aligned with the second inner channel when the bellows unit is welded to the motor, and wherein the first inner diameter is approximately the same as the second inner diameter.

Example 15 is a method comprising: providing a system that includes bellows unit and a motor for use in a wellbore, the bellows unit positioned downstream from the motor and welded to the motor via a welding surface of a flange of the motor adjacent to the bellows unit; and performing a wellbore operation in the wellbore using the system.

Example 16 is the method of example 15, wherein the flange is integrated into the motor and included in a motor base, and wherein the bellows unit is welded to the motor via the motor base.

Example 17 is the method of example 15, wherein the flange is formed separate from the motor and is coupled with a lower surface of the motor to allow the bellows unit to be welded to the motor via the flange.

Example 18 is the method of example 15, wherein the bellows unit comprises: a plurality of convolutions extending from a first end of the bellows unit to a second end of the bellows unit; a set of threads positioned around the first end of the bellows unit to facilitate a connection between a bellows housing and the bellows unit; and a first surface positioned at the first end of the bellows unit, wherein the first surface is welded to the welding surface to allow the bellows unit to be welded to the motor.

Example 19 is the method of example 18, wherein the first surface has a first normal line and the welding surface has a second normal line, and wherein the first normal line extends in an opposite direction from the second normal line when the first surface is welded to the welding surface.

Example 20 is the method of example 18, wherein the first surface has a first shape and a first thickness, wherein the welding surface has a second shape and a second thickness, wherein the first shape is approximately the same as the second shape, and wherein the first thickness is approximately the same as the second thickness.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a motor positionable in a wellbore;
a bellows unit positionable downstream from the motor; and
a flange positionable between the motor and the bellows unit, the flange comprising a welding surface adjacent to the bellows unit, the welding surface sized and shaped to allow the bellows unit to be welded to the motor.

2. The system of claim 1, wherein the flange is integrated into the motor and included in a motor base, and wherein the bellows unit is weldable to the motor via the motor base.

3. The system of claim 1, wherein the flange is formable separate from the motor and is couplable with a lower surface of the motor to allow the bellows unit to be welded to the motor via the flange.

4. The system of claim 1, wherein the bellows unit comprises:
a plurality of convolutions extending from a first end of the bellows unit to a second end of the bellows unit;
a set of threads positionable around the first end of the bellows unit to facilitate a connection between a bellows housing and the bellows unit; and
a first surface positionable at the first end of the bellows unit, wherein the first surface is weldable to the welding surface to allow the bellows unit to be welded to the motor.

5. The system of claim 4, wherein the first surface has a first normal line and the welding surface has a second normal line, and wherein the first normal line extends in an opposite direction from the second normal line when the first surface is welded to the welding surface.

6. The system of claim 4, wherein the first surface has a first shape and a first thickness, wherein the welding surface has a second shape and a second thickness, wherein the first shape is approximately the same as the second shape, and wherein the first thickness is approximately the same as the second thickness.

7. The system of claim 1, wherein the flange defines a first inner channel having a first inner diameter, wherein the bellows unit defines a second inner channel having a second inner diameter, wherein the first inner channel is aligned with the second inner channel when the bellows unit is welded to the motor, and wherein the first inner diameter is approximately the same as the second inner diameter.

8. A system comprising:
a motor positionable in a wellbore, the motor comprising a motor base positionable on a downstream side of the motor, the motor base comprising a welding surface; and
a bellows unit positionable downstream from the motor and positionable adjacent to the welding surface, the welding surface sized and shaped to allow the bellows unit to be welded to the motor.

9. The system of claim 8, further comprising a flange integrated into the motor base, wherein the bellows unit is weldable to the motor via the flange of the motor base.

10. The system of claim 9, wherein the flange is formable separate from the motor and is couplable with the motor base to allow the bellows unit to be welded to the motor via the flange.

11. The system of claim 8, wherein the bellows unit comprises:
a plurality of convolutions extending from a first end of the bellows unit to a second end of the bellows unit;
a set of threads positionable around the first end of the bellows unit to facilitate a connection between a bellows housing and the bellows unit; and
a first surface positionable at the first end of the bellows unit, wherein the first surface is weldable to the welding surface to allow the bellows unit to be welded to the motor.

12. The system of claim 11, wherein the first surface has a first normal line and the welding surface has a second normal line, and wherein the first normal line extends in an opposite direction from the second normal line when the first surface is welded to the welding surface.

13. The system of claim 11, wherein the first surface has a first shape and a first thickness, wherein the welding surface has a second shape and a second thickness, wherein the first shape is approximately the same as the second shape, and wherein the first thickness is approximately the same as the second thickness.

14. The system of claim 8, wherein the motor base defines a first inner channel having a first inner diameter, wherein the bellows unit defines a second inner channel having a second inner diameter, wherein the first inner channel is aligned with the second inner channel when the bellows unit is welded to the motor, and wherein the first inner diameter is approximately the same as the second inner diameter.

15. A method comprising:
providing a system that includes bellows unit and a motor for use in a wellbore, the bellows unit positioned downstream from the motor and welded to the motor via a welding surface of a flange of the motor adjacent to the bellows unit; and
performing a wellbore operation in the wellbore using the system.

16. The method of claim 15, wherein the flange is integrated into the motor and included in a motor base, and wherein the bellows unit is welded to the motor via the motor base.

17. The method of claim 15, wherein the flange is formed separate from the motor and is coupled with a lower surface of the motor to allow the bellows unit to be welded to the motor via the flange.

18. The method of claim 15, wherein the bellows unit comprises:
a plurality of convolutions extending from a first end of the bellows unit to a second end of the bellows unit;
a set of threads positioned around the first end of the bellows unit to facilitate a connection between a bellows housing and the bellows unit; and
a first surface positioned at the first end of the bellows unit, wherein the first surface is welded to the welding surface to allow the bellows unit to be welded to the motor.

19. The method of claim 18, wherein the first surface has a first normal line and the welding surface has a second normal line, and wherein the first normal line extends in an opposite direction from the second normal line when the first surface is welded to the welding surface.

20. The method of claim 18, wherein the first surface has a first shape and a first thickness, wherein the welding surface has a second shape and a second thickness, wherein the first shape is approximately the same as the second shape, and wherein the first thickness is approximately the same as the second thickness.
